(19) United States
(12) Patent Application Publication
(10) Pub. No.: US 2021/0398087 A1
(43) Pub. Date: Dec. 23, 2021

(54) PLANNING DEVICE, PLANNING METHOD, AND PROGRAM

(71) Applicant: MITSUBISHI HEAVY INDUSTRIES, LTD., Tokyo (JP)

(72) Inventor: Shunsaku MATSUMOTO, Tokyo (JP)

(21) Appl. No.: 17/329,400

(22) Filed: May 25, 2021

(30) Foreign Application Priority Data
Jun. 17, 2020 (JP) 2020-104272

(51) Int. Cl. G06Q 10/00; G06F 30/28

(52) U.S. Cl. CPC G06Q 10/20; G06F 2111/10; G06F 30/28

(57) ABSTRACT

A focus identification unit identifies, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition. A plan generation unit generates at least one of an operation plan and a maintenance plan such that the assessment metric is optimized with respect to the focus subsystem.

### CROSS-REFERENCE TO RELATED APPLICATIONS

This application claims the benefit of priority to JP 2020-104272 filed on Jun. 17, 2020. The entire contents of the above-identified application are hereby incorporated by reference.

### TECHNICAL FIELD

The present disclosure relates to a planning device, a planning method, and a program.

### RELATED ART

US 2019/0,121,334 A discloses, with respect to complex systems that have many subsystems, such as plants, a technique for extracting locations responsible for overall production loss of a plant.

### SUMMARY

However, the operation and maintenance of a target system are in a trade-off relationship with each other, making it difficult to optimize both. The technique disclosed in US 2019/0,121,334 A extracts subsystems responsible for production loss by comparing sensor data of a target system with a digital model of the system. Some subsystems, however, do not contribute to improved productivity even if maintenance is carried out in a focused manner. For example, it is difficult to improve productivity even when considering a maintenance plan with respect to a subsystem in which the frequency of system failure does not change regardless of maintenance conditions.

An object of the present disclosure is to provide a planning device, a planning method, and a program capable of efficiently generating a plan such that the plan is optimized with respect to a subsystem whose profit, reliability, and risk are particularly highly sensitive to modification of an operation plan or a maintenance plan.

According to a first aspect of the present invention, a planning device includes: a focus identification unit configured to identify, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and a plan generation unit configured to generate at least one of an operation plan and a maintenance plan such that the assessment metric is optimized with respect to the focus subsystem.

According to a second aspect of the present invention, a planning method includes: identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and generating at least one of an operation plan and a maintenance plan such that the assessment metric is optimized with respect to the focus subsystem.

According to a third aspect of the present invention, a program causes a computer to execute the following: identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and generating at least one of an operation plan and a maintenance plan such that the assessment metric is optimized with respect to the focus subsystem.

According to at least one aspect of the aspects described above, it is possible to efficiently generate a plan such that the plan is optimized with respect to a subsystem whose profit, reliability, and risk are particularly highly sensitive to modification of the operation plan or maintenance plan.

### BRIEF DESCRIPTION OF DRAWINGS

The disclosure will be described with reference to the accompanying drawings, wherein like numbers reference like elements.

FIG. 1 is a schematic block diagram illustrating a configuration of a management device according to a first embodiment.

FIG. 2 is a flowchart illustrating a method for generating a plan according to the first embodiment.

FIG. 3 is a diagram illustrating an example of estimation results for a time series of probabilities of failure of a target system according to the first embodiment.

FIG. 4 is a diagram illustrating an example of the relationship between preventive maintenance cost and breakdown maintenance cost according to the first embodiment.

FIG. 5 is a first diagram illustrating an example of output of an operation window according to the first embodiment.

FIG. 6 is a second diagram illustrating an example of output of an operation window according to the first embodiment.

FIG. 7 is a diagram illustrating comparison information of the probability of breakage for each operation plan.

FIG. 8 is an example of a diagram illustrating a state of a focus subsystem according to the first embodiment.

FIG. 9 is an example of graph data illustrating the relationship between the degree of opening of a choke valve and the erosion rate of a pipe.

FIG. 10 is an example of service life prediction data based on pipe thickness.

FIG. 11 is a schematic block diagram illustrating functions of a management device.

FIG. 12 is a diagram illustrating an input/output relationship of an FMEA module.

FIG. 13 is a diagram illustrating an input/output relationship of a failure assessment module.

FIG. 14 is a diagram illustrating an input/output relationship of a maintenance assessment module.

FIG. 15 is a diagram illustrating an input/output relationship of a RAM analysis module.

FIG. 16 is a diagram illustrating an input/output relationship of an equipment risk assessment module.

FIG. 17 is a schematic block diagram illustrating a configuration of a computer according to at least one embodiment.

### DESCRIPTION OF EMBODIMENTS

### First Embodiment

### Configuration of Management Device 1

Embodiments will be described in detail hereinafter with reference to the appended drawings.

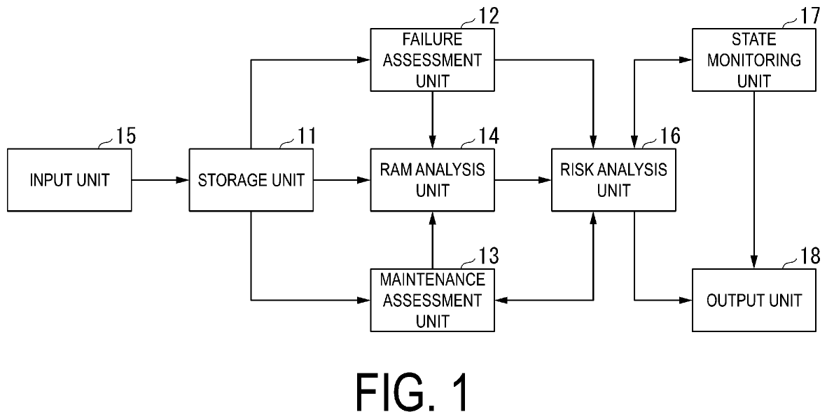

FIG. 1 is a schematic block diagram illustrating a configuration of a management device 1 according to a first embodiment.

The management device 1 according to the first embodiment generates an operation plan and a maintenance plan for a target system including a plurality of subsystems. The management device 1 is an example of a planning device. Examples of the target system include an industrial plant, such as a power plant and a petroleum production plant.

The management device 1 includes a storage unit 11, a failure assessment unit 12, a maintenance assessment unit 13, a reliability, availability, and maintainability (RAM) analysis unit 14, an input unit 15, a risk analysis unit 16, a state monitoring unit 17, and an output unit 18.

The storage unit 11 stores data related to failure risk of a target system found by failure mode and effects analysis (FMEA) performed at the time of designing of the target system. Specifically, the storage unit 11 stores a list of failure modes, a reliability block diagram, a failure rate database, and a mathematical model of a subsystem.

The list of failure modes is a list in which a subsystem included in a target system that has a possibility of failure, failure modes of the subsystem, and impact (risk priority number) of the failure modes are associated with one another.

The reliability block diagram is data indicating connection among the failures of subsystems. Reliability block diagrams do not have to be image data, and may be any data that allows a computer to identify relationships among the subsystems. Each subsystem represented in a reliability block diagram is divided on a maintenance management unit basis.

The failure rate database is a database that stores data related to the failure rate of each subsystem. The data stored in the failure rate database is not limited to that obtained by FMEA, and may be obtained from a public reliability database, a proprietary private database, a weighted combination of public data and private data, or the like.

The mathematical model of a subsystem is a model for simulating behavior related to the failure of the subsystem. A mathematical model is achieved, for example, by a statistical model (data-driven model) generated from data in the failure rate database, a physical model, or a hybrid model of both. Note that, in general, building physical models requires detailed design information of the subsystem and requires more effort than statistical models. Thus, in the initial state of the management device 1, the storage unit 11 may only store a statistical model as a mathematical model.

The failure assessment unit 12 assesses failure of each subsystem based on a mathematical model stored in the storage unit 11. Specifically, the failure assessment unit 12 calculates a statistical failure rate of each subsystem based on the mathematical model stored in the storage unit 11. The failure assessment unit 12 identifies by simulation, with respect to each subsystem, a standard operation window for keeping the risk of failure below a predetermined threshold, and a critical operation window, exceeding which immediately causes failure. For example, the failure assessment unit 12 calculates a statistical failure rate as well as a standard operation window and a critical operation window by simulating failure of the subsystem with Monte Carlo simulation using a statistical model. Furthermore, the failure assessment unit 12 determines a time series of probabilities of failure based on the operation plan and the maintenance plan as well as the mathematical model stored in the storage unit 11.

The maintenance assessment unit 13 generates maintenance conditions at which the cost or the time required for maintenance is minimal. Maintenance conditions include conditions relating to breakdown maintenance for each failure mode of each subsystem, and conditions relating to preventive maintenance of each subsystem. For example, the maintenance assessment unit 13 uses a statistical model based on actual maintenance results data of other systems that have subsystems similar to those of the target system to determine the time and labor required for maintaining the target subsystem from the type of target subsystem, statistical failure rates, and unit costs relating to the use of labor and heavy machines, and the like. Furthermore, the maintenance assessment unit 13 calculates the time and cost required for maintenance based on the maintenance conditions of the subsystem and the unit costs relating to the use of labor and heavy machines, and the like.

The RAM analysis unit 14 calculates the reliability, availability, and profitability of each subsystem based on the reliability block diagram stored in the storage unit 11, the statistical failure rate of each subsystem calculated by the failure assessment unit 12, the time and cost required for maintenance calculated by the maintenance assessment unit 13, as well as the maintenance schedule. The RAM analysis unit 14 calculates the reliability, availability, and severity of each subsystem by a Monte Carlo simulation, for example. Severity is a quantitative representation, expressed in an amount of money or the like, of the maintenance cost that occurs due to failure of subsystems, losses associated with stoppage of system operation, personal damage, environmental damage, loss of credibility, compensation for failure to achieve guaranteed availability, and the like. The RAM analysis unit 14 identifies, as a focus subsystem, any subsystem whose reliability, availability, and severity changes greatly in response to changes in the operation condition or the maintenance condition.

The input unit 15 receives, as input, a physical model of the focus subsystem identified by the RAM analysis unit 14. The inputted physical model is recorded in the storage unit 11.

The risk analysis unit 16 is configured to identify, by simulation using a physical model of the focus subsystem identified by the RAM analysis unit 14, for the focus subsystem, an optimal operation window such that the amount of money obtained by subtracting the maintenance cost and the impact of failure from profit from system operation is the greatest. The optimal operation window is included in the standard operation window.

The risk analysis unit 16 generates an operation plan such that the amount of money obtained by subtracting the maintenance cost and the impact of failure from the profit from system operation is the greatest. In searching for an operation plan, the risk analysis unit 16 limits the operation window of the focus subsystem to within the optimal operation window to reduce the amount of computation. The risk analysis unit 16 determines a maintenance schedule based on the generated operation plan so as to reduce the maintenance cost or probability of failure.

The state monitoring unit 17 assesses the state of the focus subsystem based on the operation plan and maintenance plan generated by the risk analysis unit 16, as well as measurement values of sensors provided in the actual system. For example, the state monitoring unit 17 predicts the extent of deterioration in the focus subsystem, time remaining until failure occurs, and the like.

The output unit 18 outputs the operation plan and maintenance plan, optimal operation window, standard operation window, and critical operation window determined by the risk analysis unit 16, as well as the state assessment by the state monitoring unit 17 to a display or other component.

### Operation of Management Device 1

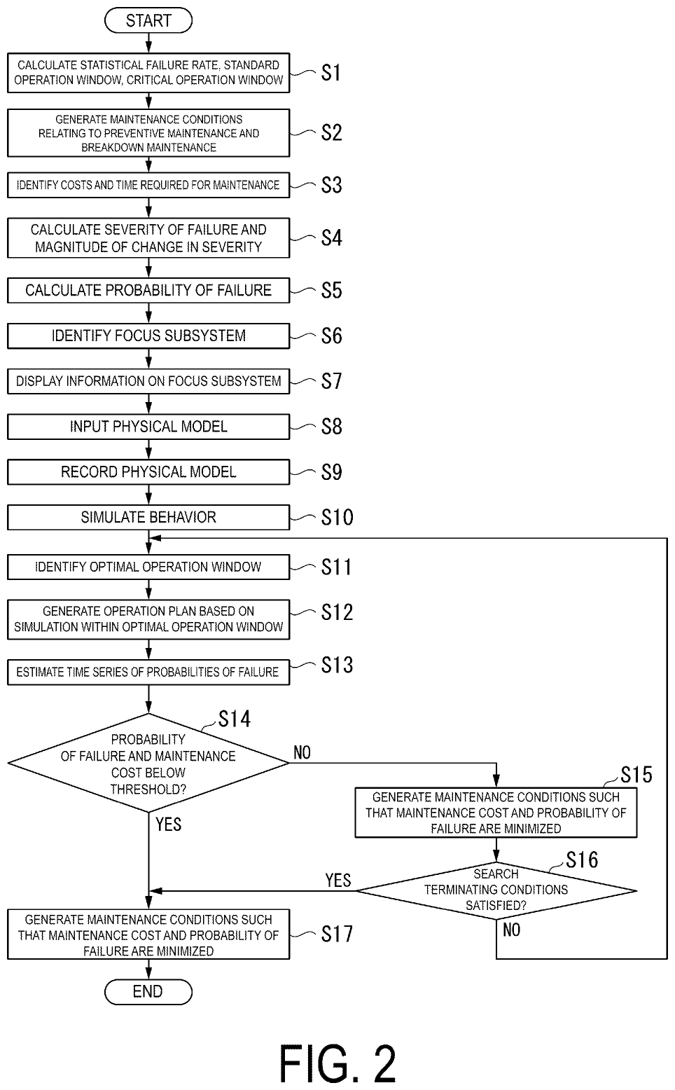

Next, a method for generating an operation plan and a maintenance plan of the target system using the management device 1 will be described. FIG. 2 is a flowchart illustrating a method for generating a plan according to the first embodiment.

The list of failure modes, reliability block diagram, and failure rate database obtained by the FMEA performed at the time of designing the target system are stored in the storage unit 11 in advance. Furthermore, based on the failure rate database stored in the storage unit 11, the administrator generates a statistical model of each subsystem in which a failure may occur, and records the same in the storage unit 11. Statistical models may be automatically generated by the management device 1 based on the failure rate database.

When the management device 1 starts generating a plan, the failure assessment unit 12 calculates the statistical failure rate, standard operation window, and critical operation window of each subsystem based on the statistical model stored in the storage unit 11 (step S1).

Next, the maintenance assessment unit 13 generates maintenance conditions relating to breakdown maintenance for each failure mode of each subsystem stored in the storage unit 11 and maintenance conditions relating to preventive maintenance of each subsystem such that the cost or the time required for maintenance is minimal (step S2). The maintenance assessment unit 13 may generate appropriate maintenance conditions by modifying preset initial maintenance conditions, or may generate new maintenance conditions. The maintenance assessment unit 13 identifies required cost and time with respect to each of the generated maintenance conditions (step S3).

The RAM analysis unit 14 calculates the magnitude of severity of failure of each subsystem based on the time and cost required for maintenance calculated in step S3 as well as the statistical model stored in the storage unit 11 (step S4). Furthermore, the RAM analysis unit 14 calculates the failure risk of each subsystem during a certain operation period as degree of importance based on the reliability block diagram stored in the storage unit 11, the statistical failure rate of each subsystem calculated in step S1, and the severity of failure calculated in step S4 (step S5). Note that the severity multiplied by the probability of failure indicates the magnitude of risk, and corresponds to the assessment metric of the first embodiment. The RAM analysis unit 14 identifies any subsystems whose degree of importance calculated in step S5 is greater than a predetermined threshold as a focus subsystem (step S6). Note that, in other embodiments, the RAM analysis unit 14 may identify a predetermined number of subsystems that rank higher in terms of greater degree of importance as focus subsystems. The RAM analysis unit 14 causes identification information (such as model number, name, and installation location) of the identified focus subsystem to be displayed on a display or other component (step S7). This allows the administrator to recognize any focus subsystems that require a physical model to be created.

The administrator generates a physical model that simulates failure with respect to any focus subsystems displayed in step S7, and in particular with respect to any subsystems whose probability of failure may vary due to difference in maintenance conditions or operation conditions. At this time, the administrator preferably generates a plurality of simulation models that simulate different physical phenomena with respect to one focus subsystem. For example, in cases where the focus subsystem is a pipe for transporting a fluid containing solids, a simulation model based on fluid analysis and a simulation model that simulates wear can be generated.

The input unit 15 receives input from the administrator of a physical model of a focus subsystem (step S8). The input unit 15 records the physical model in the storage unit 11, with the physical model being associated with the identification information of the focus subsystem (step S9).

The risk analysis unit 16 simulates behavior of the target system by using the physical models of the focus subsystems stored in the storage 11 and statistical models of the other subsystems (step S10). Based on simulation results, the risk analysis unit 16 identifies, with respect to the focus subsystem, an optimal operation window such that the amount of money obtained by subtracting the maintenance cost and the impact of failure from the profit from system operation is the greatest (step S11). Because the optimal operation window is included in the standard operation window, the risk analysis unit 16 searches for the optimal operation window by simulating operation within the standard operation window.

Next, the risk analysis unit 16 simulates behavior of the target system while limiting the range in which control parameters of the focus subsystem can be taken to the optimal operation window identified in step S11, and generates an operation plan such that the amount of money obtained by subtracting the maintenance cost and the impact of failure from the profit from target system operation is the greatest (step S12). At this time, the risk analysis unit 16 carries out simulation such that damage progress events such as unstable vibration occur with a probability or at a preset timing.

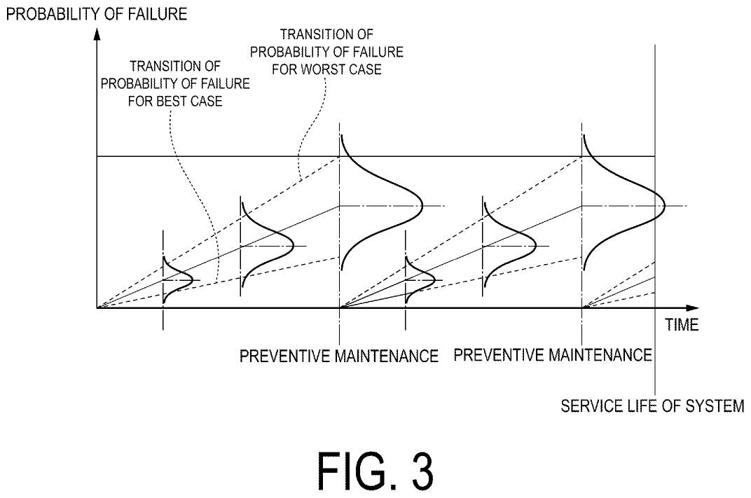

Based on the operation plan generated in step S12, the failure assessment unit 12 carries out simulation using the physical model of each of the focus subsystems, and estimates based on the schedule of preventive maintenance a time series of probabilities of failure until the end of the service life of the target system (step S13). FIG. 3 is a diagram illustrating an example of estimation results for a time series of probabilities of failure of a target system according to the first embodiment. At this time, as illustrated in FIG. 3, the failure assessment unit 12 carries out simulation, with a probability distribution ranging from the worst case to the best case being assumed with respect to the extent of deterioration that occurs to the focus subsystem. Examples of uncertainty include the extent of pipe corrosion, the amount of sand contained in the oil and gas produced from wells, and variation in properties and material strength.

The risk analysis unit 16 decides, with respect to each focus subsystem, both whether the probability of failure estimated in step S13 falls below a preset probability of failure threshold and whether the maintenance cost identified in step S13 falls below a preset cost threshold (step S14).

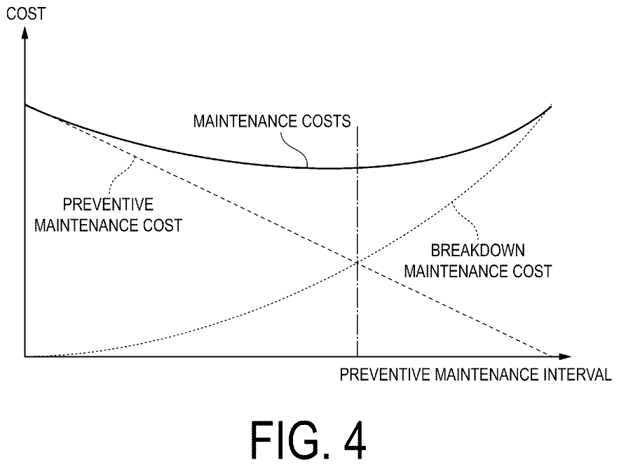

In cases where, with respect to at least one focus subsystem, at least one of the probability of failure and the maintenance cost is not less than the threshold (“NO” in step S14), the risk analysis unit 16 determines, based on the operation plan generated in step S13, a maintenance plan such that the maintenance cost and the probability of failure are minimized (step S15). For example, while making modifications to the schedule of preventive maintenance, the risk analysis unit 16 causes the maintenance assessment unit 13 to determine the preventive maintenance cost and the breakdown maintenance cost based on the operation plan generated at step S12, and determines the schedule of preventive maintenance such that the total of the preventive maintenance cost and the breakdown maintenance cost is minimal. FIG. 4 is a diagram illustrating an example of the relationship between preventive maintenance cost and breakdown maintenance cost according to the first embodiment. As illustrated in FIG. 4, the longer the interval between preventive maintenance performed, the lower the preventive maintenance cost. On the other hand, the longer the interval between preventive maintenance, the probability of failure increases, which makes the occurrence of breakdown maintenance more likely and increases the breakdown maintenance cost. The breakdown maintenance cost is found as expectation value by multiplying the cost required for actual breakdown maintenance by the probability of failure. The risk analysis unit 16 determines the schedule of preventive maintenance such that the sum of the preventive maintenance cost and the breakdown maintenance cost is minimized.

The risk analysis unit 16 decides whether the search terminating conditions for operation plans and maintenance plans are satisfied (step S16). Examples of search terminating conditions include that the processing from step S11 to step S16 has been repeated for a predetermined number of times, and that the rate of change for the amount of money obtained by subtracting the maintenance cost and the impact of failure from the profit from target system operation found in step S12 falls below a predetermined value. If the search terminating conditions are not satisfied (“NO” in step S16), the risk analysis unit 16 returns to step S10 to simulate the behavior of the target system based on the preventive maintenance schedule determined in step S15. This is because, as the preventive maintenance schedule is modified, the probability of failure changes, which in turn changes the profit from target system operation, maintenance cost, and impact of failure of the target system.

On the other hand, in cases where, with respect to all of the focus subsystems, both the probability of failure and the maintenance cost are less than the threshold in step S14 (“YES” in step S14), or in cases where the search terminating conditions are satisfied in step S16 (“YES” in step S16), the output unit 18 outputs the generated operation plan and maintenance plan, as well as the optimal operation window (step S17).

For example, the output unit 18 receives, as selection by the user, one or two of the control parameters of the focus subsystem, and outputs a graph of the operation window with each selected control parameter serving as axis.

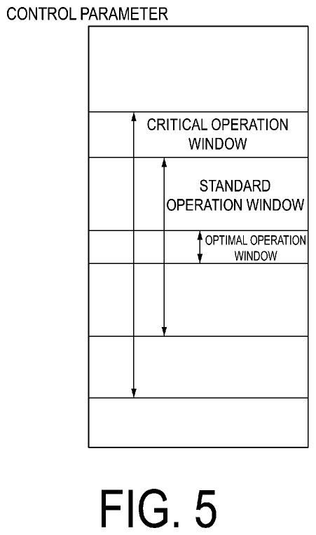

FIG. 5 is a first diagram illustrating an example of output of an operation window according to the first embodiment.

Upon receiving as selection one of the control parameters of the focus subsystem, the output unit 18 outputs a one-dimensional graph representing the critical operation window, the standard operation window, and the optimal operation window of the selected control parameter, as illustrated in FIG. 5.

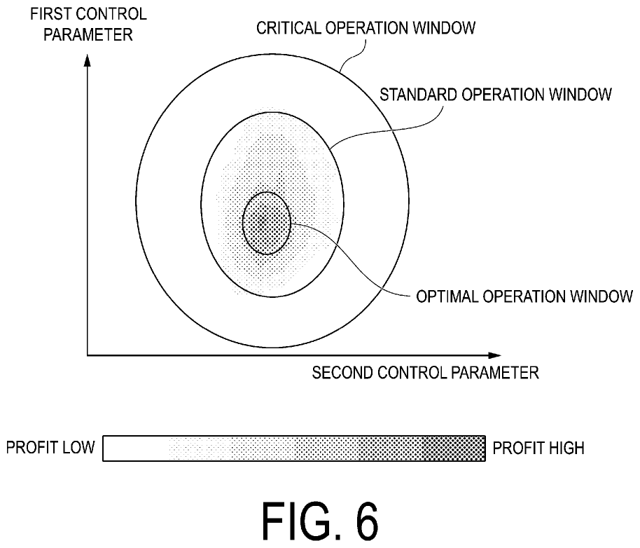

FIG. 6 is a second diagram illustrating an example of output of an operation window according to the first embodiment. Upon receiving as selection two of the control parameters of the focus subsystem, the output unit 18 outputs a two-dimensional graph with the two selected control parameters serving as axes. As illustrated in FIG. 6, the two-dimensional graph indicates the magnitude of profit in a heat map, and has enclosing lines representing the critical operation window, the standard operation window, and the optimal operation window.

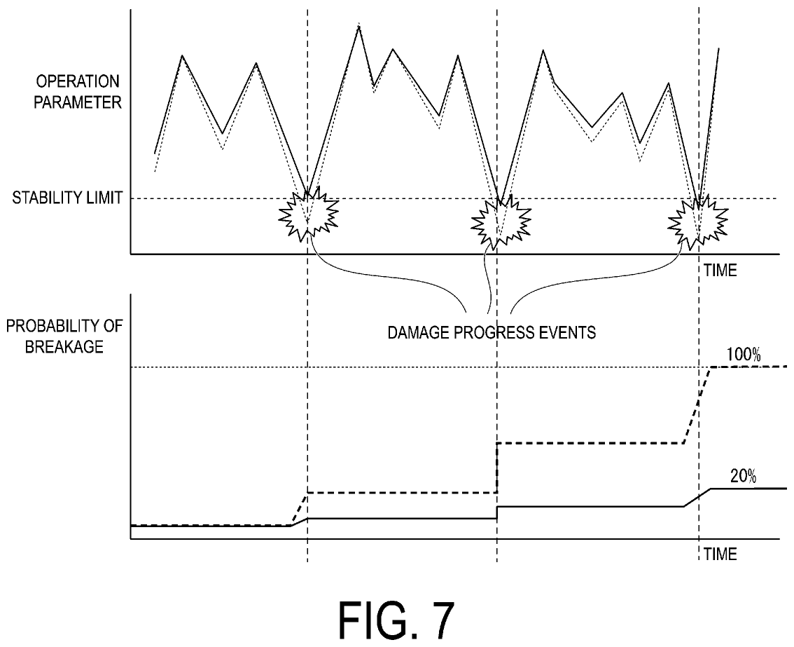

Furthermore, when outputting the operation plan and the maintenance plan, the output unit 18 may also output economical comparison information based on simulation results for the plan according to the initial conditions and the optimized plan. For example, as illustrated in FIG. 7, the output unit 18 may output a graph comparing a time series of probabilities of breakage when operating based on the operation plan and maintenance plan generated by the management device 1, and a time series of probabilities of breakage when operating based on the plan according to the initial conditions. FIG. 7 is a diagram illustrating comparison information of the probability of breakage for each operation plan. The information is generated using the simulation results of step S13, for example. That is, the simulation results include occurrences of damage progress events, such as unstable vibration.

When the target system starts operation, the state monitoring unit 17 of the management device 1 collects measurement values from sensors of the target system. The state monitoring unit 17 assesses the state of the focus subsystem based on acquired measurement values as well as the operation plan and maintenance plan generated by the risk analysis unit 16. Specifically, the state monitoring unit 17 carries out simulation based on acquired measurement values using the physical model of the focus subsystem stored in the storage unit 11 to estimate the current state of the focus subsystem. Then, the state monitoring unit 17 predicts a time series of future probabilities of failure based on the operation plan and maintenance plan generated by the risk analysis unit 16.

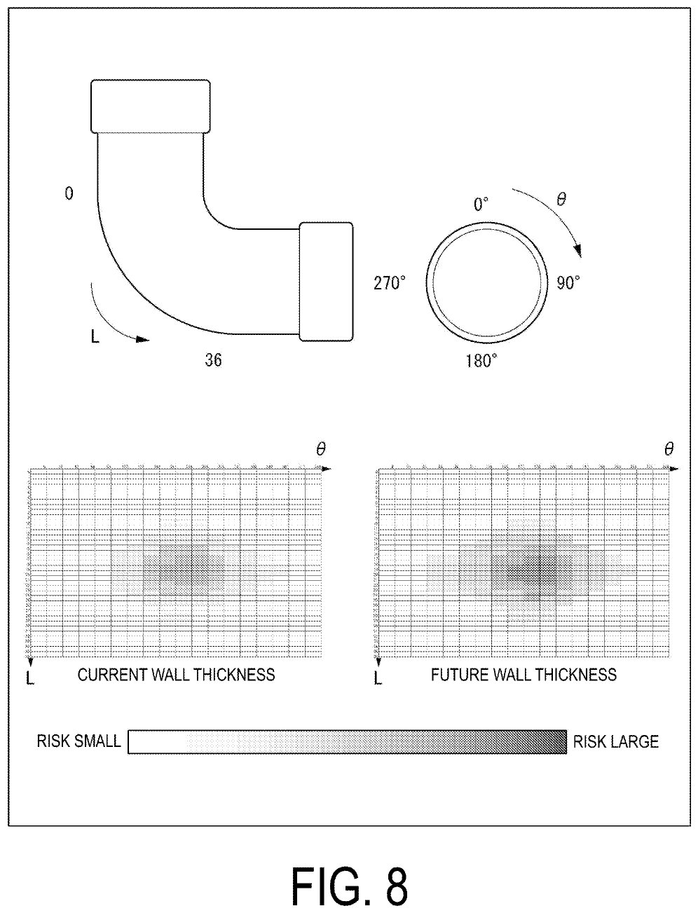

The output unit 18 outputs the state of the focus subsystem assessed by the state monitoring unit 17. FIG. 8 is an example of a diagram illustrating a state of a focus subsystem according to the first embodiment. As illustrated in FIG. 8, for example, the output unit 18 outputs a diagram showing a correspondence relationship when a site of the focus subsystem is projected onto a two-dimensional map, a map indicating a state assessed based on historical operation data, and a map indicating service life prediction results that are based on future operation prediction based on the operation plan and the maintenance plan. Note that in the drawing illustrated in FIG. 8, the focus subsystem is an L-shaped pipe, and the deterioration factor is erosion.

### Operational Effects

In this way, according to the first embodiment, the management device 1 identifies, based on a mathematical model that simulates behavior of a plurality of subsystems constituting a target system, a focus subsystem from among the plurality of subsystems, and generates an operation plan and a maintenance plan such that an assessment metric is optimized with respect to the focus subsystems. This allows the management device 1 to efficiently generate a plan such that the plan is optimized with respect to subsystems whose profit, reliability, and risk are particularly highly sensitive to modification of the operation plan and maintenance plan.

Furthermore, according to the first embodiment, the management device 1 identifies the focus subsystem by carrying out RAM analysis based on a mathematical model of a subsystem that constitutes the target system and that has a possibility of failure. This makes it possible to identify, based on potential losses at the time of failure and the reliability of subsystems, a subsystem whose profit, reliability, and risk are highly sensitive to modification of the operation plan and maintenance plan.

According to the first embodiment, the management device 1 carries out RAM analysis of the target system as a whole by using statistical models of the subsystems, and for focus subsystems, carries out risk analysis thereof using physical models. In this way, according to the first embodiment, the management device 1 can efficiently generate a plan by limiting the generation of physical models, which requires knowledge and effort, to equipment that calls for detailed failure risk assessment.

### Application Example

The inventor applied the management device 1 described above in considering an operation plan and a maintenance plan for a pipeline system. As a result of RAM analysis according to the procedure described above, in the pipeline system, a particular pipe in which a failure mode due to erosion occurs was extracted as a focus subsystem. Accordingly, the inventor generated, with respect to the pipe, a hydrodynamic model that simulates pipe erosion due to particles and a physical wear model that simulates wear. In this way, generating simulation models based on a plurality of different viewpoints for one subsystem can appropriately simulate complex phenomena relating to failure. The hydrodynamic model and the physical wear model have, as variables, particle diameter and composition, flow rate of the fluid, the material and surface state of the pipe, and the state of multiphase flow.

Specifically, the models were generated according to the following procedure. First, in a focus subsystem, the area and dimension to be modeled were determined. Next, a three-dimensional model of the focus subsystem was generated. The three-dimensional model included a pipe, a device, a valve, and the like. Next, ranges that the variables of the fluid can take were determined. Examples of variables include Gas Fluid Ratio (GFR), concentration, viscosity, pressure, temperature, and speed of the fluid, as well as hardness and size of sand particles. Next, the composition of each site of the focus subsystem was set for the model. A function of erosion rate was set for the model. Next, ranges of control parameters were set. Next, a state relating to hydrodynamics and a matrix used for hydrodynamic analysis were generated.

The risk analysis unit 16 of the management device 1 searches for operation conditions of the valve degree of opening that regulates the flow rate of the fluid based on the above-described model, and generates an operation plan including a damage growth event based on the operation conditions. The risk analysis unit 16 predicts the service life due to wear of the pipe of the focus subsystem based on the generated operation plan. The output unit 18 outputs, as dashboard data, graph data indicating the relationship between the valve degree of opening and wear rate of the pipe of the focus subsystem, operation analysis results including damage progress events (FIG. 7), and service life prediction data based on pipe thickness.

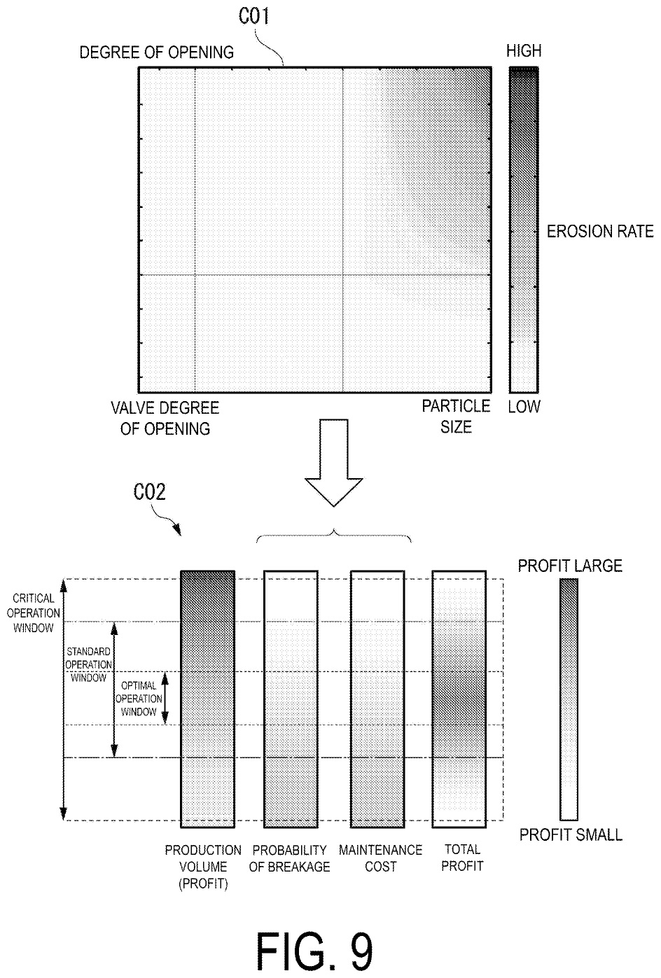

FIG. 9 is an example of graph data illustrating the relationship between the degree of opening of a choke valve and the erosion rate of a pipe. The risk analysis unit 16 generates, by a hydrodynamic model, a contour map C01 representing an erosion rate for a combination of valve opening and particle size, as illustrated in FIG. 9. The risk analysis unit 16 determines the relationship among valve degree of opening, breakage risk, and maintenance cost based on the generated contour map. That is, the higher the erosion rate in the contour map, the higher the breakage risk and maintenance cost. The risk analysis unit 16 identifies an optimal operation window such that the amount of money obtained by subtracting the maintenance cost and the impact of failure from the profit from system operation is the greatest. Then, when the user selects the valve degree of opening of the focus subsystem as the target to be displayed, the output unit 18 outputs a one-dimensional graph C02 representing the critical operation window, the standard operation window, and the optimal operation window of the valve degree of opening, as illustrated in FIG. 9.

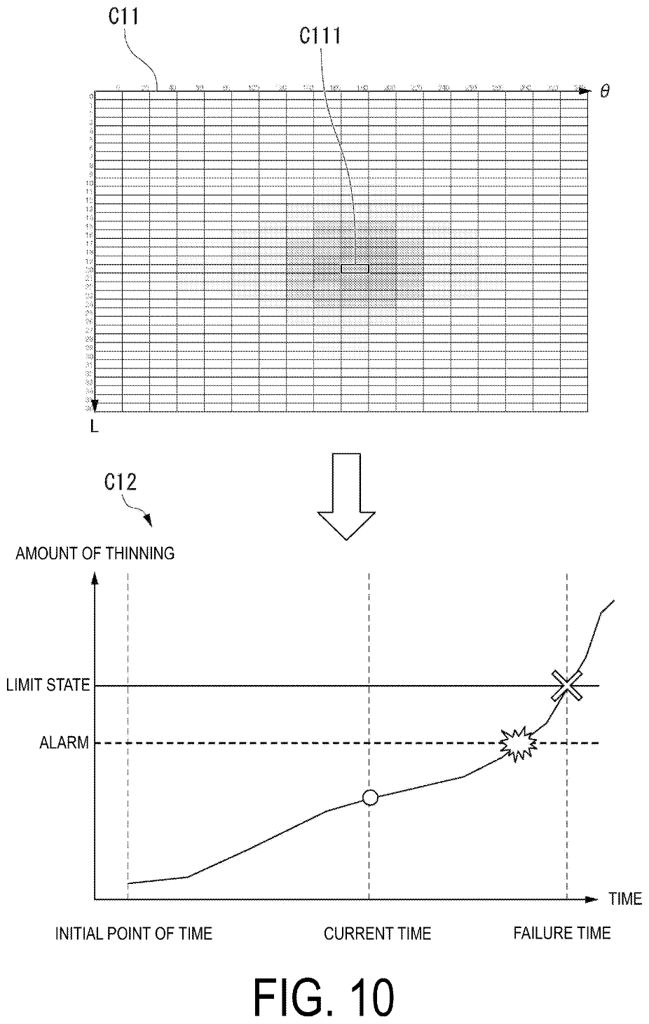

FIG. 10 is an example of service life prediction data based on pipe thickness.

The output unit 18 outputs a contour map C11 indicating the current state assessed based on operation data. The management device 1 receives a designation by the user of any site of the focus subsystem within the displayed contour map C11. When the user specifies one site, the output unit 18 highlights a specified site C111 in the contour map C11. The output unit 18 outputs a graph C12 of a time series of amount of thinning of the site. The output unit 18 generates a graph of the amount of thinning from the initial point of time to the current time based on historical operation data. Furthermore, the output unit 18 generates a graph of the amount of thinning from the current time to a failure time based on service life prediction results that are based on future operation prediction based on the operation plan and the maintenance plan. Note that the output unit 18 may change the time displayed on the contour map C11 in cases where a designation by the user of any time on the graph C12 is received.

In this way, the inventor was able to demonstrate usefulness of the management device 1 described above in pipeline systems.

### Other Embodiments

Although an embodiment has been described in detail with reference to the drawings, specific configurations are not limited to those described above, and various design changes and the like can be made. That is, in other embodiments, the above-described order of processing may be modified as appropriate. Furthermore, part of the processing may be performed in parallel.

The management device 1 according to the above-described embodiment may be constituted by a single computer. Alternatively, the configuration of the management device 1 may be divided into a plurality of computers and arranged such that the plurality of computers collaborate with one another and function as the management device 1.

### Overview of the Management Device 1

An industrial system can be separated into subsystems and elements. For example, there are a valve body, valve stem, inlet pipe, outlet pipe, and the like around the top side choke valve of an oil and gas platform, and these can be considered as elements. For general operation conditions, a damage mechanism corresponding to each site is defined. To predict the amount of damage, high-fidelity models that simulate physical phenomena such as computational fluid dynamics (CFD) and finite element analysis (FEA) are often required.

However, building these high-fidelity models requires not only computer costs (money and time) but also comprehensive domain knowledge and various design information, and information gathering and implementation of computation are costly. Therefore, there is a demand for implementing a high-fidelity model only for limited equipment judged to be high-risk from the standpoints of safety, availability, profitability, and the like.

RAM analysis is a probabilistic risk assessment tool for efficiently improving system availability and profitability through technical risk management of large-scale mechanical systems and optimization of resources related to countermeasures. Because RAM analysis typically uses statistical failure rate, which is a type of data-driven model, RAM analysis can be applied to elements of large-scale industrial systems.

That is, optimization of operations and maintenance (O&M) in industrial systems begins by first identifying main failure modes and target sites by FMEA, and then extracting important equipment from the standpoints of safety, availability, reliability, profitability, and the like, by RAM analysis using statistical failure rates. Then, O&M are adjusted by extracting, from among the important equipment, facilities whose risk and profitability vary due to improvement in O&M, and predicting how the amount of damage, breakage risk, and profitability vary under various combinations of operation conditions and maintenance conditions by using high-fidelity models that simulate physical phenomena such as finite element method (FEM) and computational fluid dynamics (CFD).

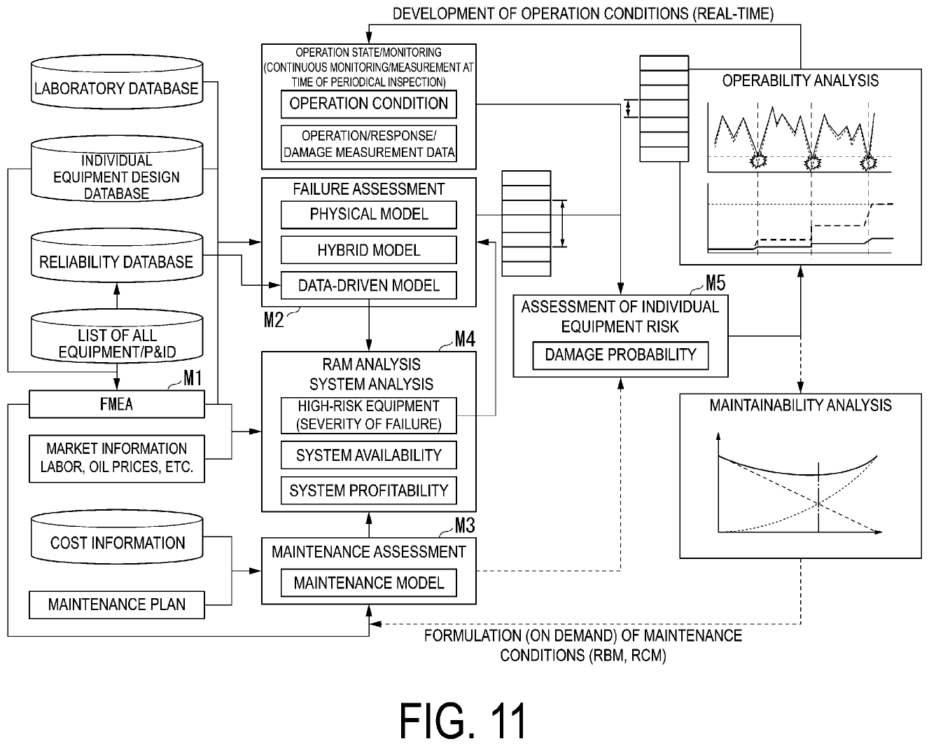

FIG. 11 is a schematic block diagram illustrating primary functions of a management device 1.

The management device 1 includes an FMPA module M1, a failure assessment module M2, a maintenance assessment module M3, a RAM analysis module M4, and an equipment risk assessment module M5.

As illustrated in FIG. 1, the general flow of processing of the management device 1 is as follows.

First, the management device 1 extracts high-risk equipment by FMEA and RAM analysis, further extracts, from the extracted equipment, equipment whose damage risk varies due to O&M, and builds models of such equipment (individual risk assessment). The management device 1 reduces computation load of operation analysis and maintenance analysis by preparing in advance a model that is capable of predicting damage and assessing probability of breakage according to many O&M conditions by using physical models such as FEM and CFD. The management device 1 causes the O&M analysis results to be reflected in maintenance conditions and operation conditions, and carries out failure risk assessment of individual equipment again (individual risk assessment).

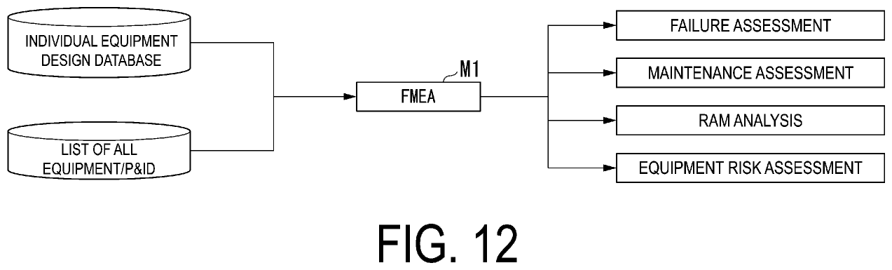

FIG. 12 is a diagram illustrating an input/output relationship of an FMEA module M1.

The FMEA module M1 assesses, for each piece of equipment, main parts/failure modes, failure mechanisms, and the severity of corresponding failures. Examples of severity include recovery time, breakdown maintenance cost, personal damage, and environmental impact. Detailed drawings and design calculation sheets of equipment are inputted from a design database to the FMEA module M1. Furthermore, a list of equipment and parts is inputted from a piping and instrumentation diagram (P&ID). The FMEA module M1 outputs a reliability block diagram to the RAM analysis module M4, and outputs a list of failure modes and severity to the failure assessment module M2, maintenance assessment module M3, and equipment risk assessment module M5.

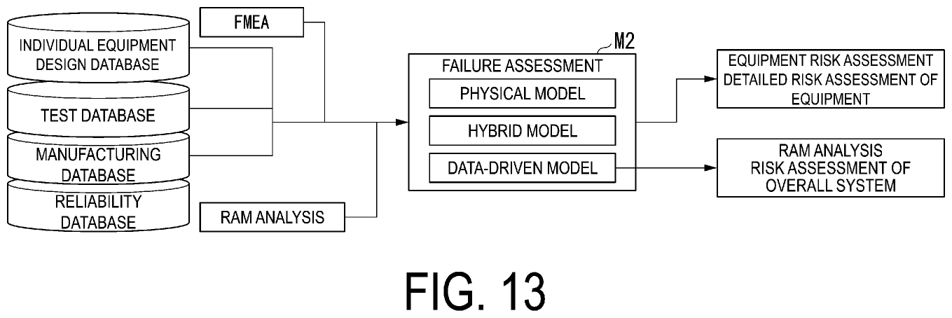

FIG. 13 is a diagram illustrating an input/output relationship of a failure assessment module.

The failure assessment module M2 carries out integrity diagnosis and service life prediction of equipment by using a physical model of the equipment, a data-driven model, or a hybrid model that combines the two. Examples of physical models include CFD, multi-body dynamics (MBD), finite element analysis (FEA), and material strength model (such as Paris' law and fatigue curve in the case of fatigue). Examples of data-driven models include survival analysis (such as a cumulative hazard method), an exponential distribution model (random failure with statistical failure rate), and abnormality sign detection (Maharanobis-Taguchi method).

A list of failure modes and severity for each piece of equipment is inputted from the FMEA module M1 to the failure assessment module M2. Detailed drawings and design calculation sheets are inputted from an individual equipment design database to the failure assessment module M2. Actual structure test results, subsystem and component test results, and element test results are inputted from a test database to the failure assessment module M2. Post-manufacture shape measurement results, heat treatment history, and processing history are inputted from a manufacture database to the failure assessment module M2. A public database (such as Offshore Reliability Data (OREDA) and Nonelectronic Parts Reliability Data (NPRD)), reliability data and field data of similar plants within a company, and reliability data and field data specific to the plant to be assessed are inputted from a reliability database to the failure assessment module M2. A list of important equipment after performing RAM analysis is inputted from the RAM analysis module M4 to the failure assessment module M2.

The failure assessment module M2 outputs a probability of breakage prediction, in which operation conditions and maintenance conditions serve as variables, to the equipment risk assessment module M5. The failure assessment module M2 outputs a statistical failure rate (exponential distribution model) to the RAM analysis module M4.

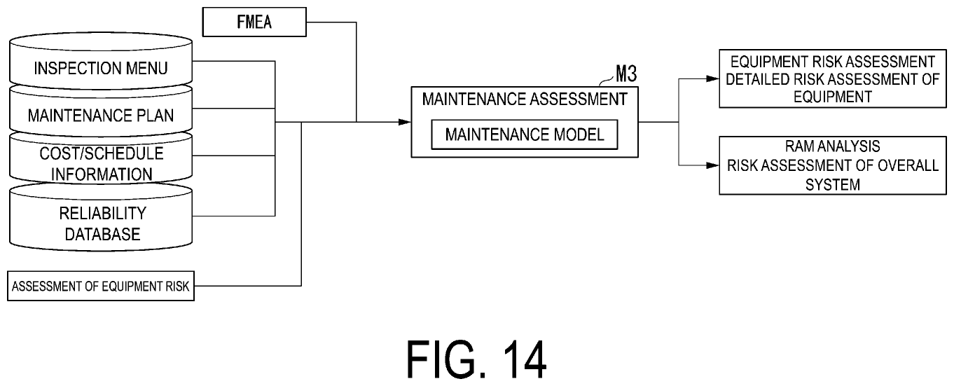

FIG. 14 is a diagram illustrating an input/output relationship of the maintenance assessment module M3.

The maintenance assessment module M3 has a preventive maintenance scheduler function for considering such a schedule as to minimize the cost and duration of requested maintenance, and a breakdown maintenance assessment function for predicting cost and required time based on activity items assumed for failure time. A list of failure modes and severity for each piece of equipment is inputted from the FMEA module M1 to the maintenance assessment module M3. As an inspection menu, inspection items for each site and each damage mode (such as visual inspection and ultrasonic inspection) are inputted to the maintenance assessment module M3. As variables for the preventive maintenance plan and the breakdown maintenance plan, processes of preventive maintenance, mid- to long-term schedules, and expected recovery processes at failure time are inputted to the maintenance assessment module M3. As cost and schedule information, labor cost, unit prices of heavy machines and supplies, abilities of workers (welding operation and operation of heavy machines), resources such as number of people, as well as work breakdown structure (WBS) are inputted to the maintenance assessment module M3. A public database (such as OREDA), reliability data and field data of similar plants within a company, and reliability data and field data specific to the plant to be assessed are inputted from a reliability database to the maintenance assessment module M3. Equipment risk assessments under each maintenance condition related to a group of important equipment are inputted from the equipment risk assessment module M5 to the maintenance assessment module M3.

The maintenance assessment module M3 outputs a recovery time at failure time, preventive maintenance cost, and breakdown maintenance cost to the equipment risk assessment module M5 and the RAM analysis module M4. Further, the maintenance assessment module M3 outputs a preventive maintenance plan to the RAM analysis module M4.

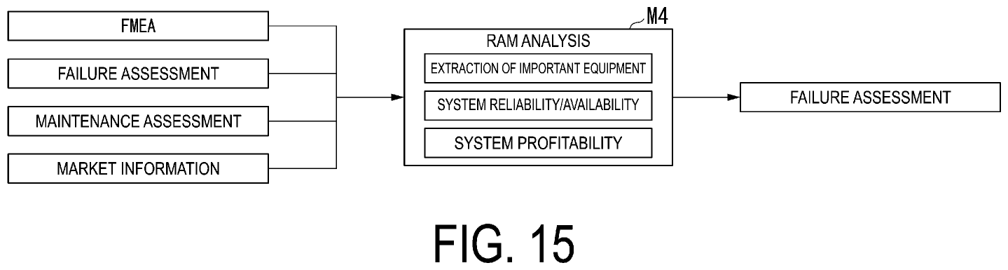

FIG. 15 is a diagram illustrating an input/output relationship of a RAM analysis module.

The RAM analysis module M4 quantifies reliability, availability, and risk (degree of importance) on an equipment level and on a system level by RAM analysis, and extracts equipment (important equipment) that has room for O&M improvement. Degree of importance is typically assessed by the product of probability of breakage and severity. Severity is assessed by system reliability, availability, impact on profitability, and the like. The RAM analysis module M4 extracts important equipment by visualizing important equipment (high-risk equipment) using Pareto charts and the like. Furthermore, the RAM analysis module M4 finds a probability distribution of system reliability, availability, and profitability.

The reliability block diagram is inputted from the FMEA module M1 to the RAM analysis module M4. The statistical failure rate is inputted from the failure assessment module M2 to the RAM analysis module M4. The preventive maintenance plan, recovery time at failure time, breakdown maintenance cost, and preventive maintenance cost are inputted from the maintenance assessment module M3 to the RAM analysis module M4. Oil prices and the like are inputted to the RAM analysis module M4 as market information.

The RAM analysis module M4 outputs extracted important equipment to the failure assessment module M2.

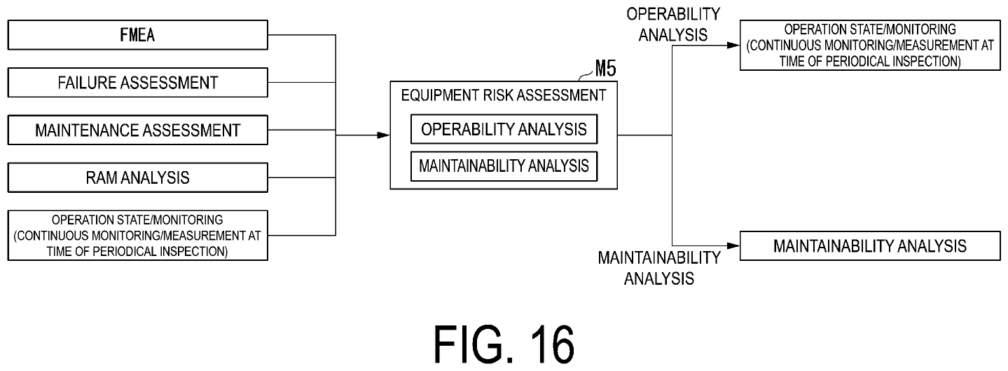

FIG. 16 is a diagram illustrating an input/output relationship of an equipment risk assessment module.

The equipment risk assessment module M5 corrects (calibrates) equipment failure predictions using obtained response measurement and inspection measurement data. Furthermore, the equipment risk assessment module M5 analyzes operability and maintainability using probability of breakage assessments of equipment (a function of operation conditions and maintenance conditions).

Failure modes and severity of important equipment are inputted from the FMEA module M1 to the equipment risk assessment module M5. Probabilities of failure of important equipment (a function of operation conditions and maintenance conditions) are inputted from the failure assessment module M2 to the equipment risk assessment module M5. The recovery time, breakdown maintenance cost, and preventive maintenance cost are inputted from the maintenance assessment module M3 to the equipment risk assessment module M5. Failure severity of important equipment is inputted from the RAM analysis module M4 to the equipment risk assessment module M5. As operation state and monitoring information, operation information, response measurements (distortion and temperature), and damage measurements (such as thinning amount) are inputted to the equipment risk assessment module M5.

The equipment risk assessment module M5 formulates optimal operation conditions in any maintenance plan for the purpose of operability analysis. The equipment risk assessment module M5 formulates optimal maintenance conditions in any operation plan for the purpose of maintainability analysis.

### Computer Configuration

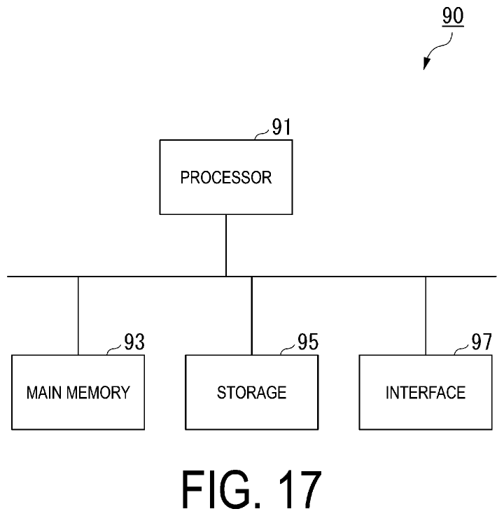

FIG. 17 is a schematic block diagram illustrating a configuration of a computer according to at least one embodiment.

A computer 90 includes a processor 91, a main memory 93, a storage 95, and an interface 97.

The above-described management device 1 is implemented in the computer 90. In addition, operation of each of the above-described processing units are stored in the storage 95 in the form of a program. The processor 91 reads a program from the storage 95, expands the same in the main memory 93, and executes the processing described above in accordance with the program. Furthermore, the processor 91 secures a storage area corresponding to each of the above-described storage units in the main memory 93 in accordance with the program. Examples of the processor 91 include a central processing unit (CPU), a graphics processing unit (GPU), and a microprocessor.

The program may be a program for achieving part of the functions that the computer 90 is caused to work. For example, the program may be a program that achieves a function by combining with another program that has been stored in the storage or combining with another program installed on another device. Note that, in other embodiments, the computer 90 may include a custom large scale integrated circuit (LSI) such as a programmable logic device (PLD), in addition to or in place of the configuration described above. Examples of the PLD include a programmable array logic (PAL), a generic array logic (GAL), a complex programmable logic device (CPLD), and a field programmable gate array (FPGA). In this case, some or all of the functions achieved by the processor 91 may be achieved by the integrated circuit. Such integrated circuits are also included in an example of the processor.

Examples of the storage 95 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 95 may be an internal medium directly connected to a bus of the computer 90, or may be an external medium connected to the computer 90 through the interface 97 or a communication line. Furthermore, in cases where this program is delivered to the computer 90 via a communication line, the computer 90 that receives the delivery may expand the program in the main memory 93 and execute the processing described above. In at least one of the embodiments, the storage 95 is a non-temporary tangible storage medium.

Further, the program may achieve some of the functions described above. Furthermore, the program may be a so-called differential file (a differential program) that achieves the functions described above in combination with another program already stored in the storage 95.

### Supplementary Notes

The planning device, planning method, and program described in each embodiment can be understood as follows, for example.

(1) According to a first aspect, a planning device (1) includes: a focus identification unit (14) configured to identify, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and a plan generation unit (16) configured to generate at least one of an operation plan and a maintenance plan such that the assessment metric is optimized with respect to the focus subsystem. “Identify” means defining a second value that can take a plurality of values by using a first value. For example, “identify” includes calculating a second value from a first value, reading out a second value corresponding to a first value by referring to a table, searching for a second value by using a first value in a query, and selecting a second value from among a plurality of candidates based on a first value. A subsystem includes a part and a component.

This allows the planning device (1) to efficiently generate a plan such that the plan is optimized with respect to subsystems whose profit, reliability, and risk are particularly highly sensitive to modification of the operation plan and maintenance plan.

(2) According to a second aspect, in the planning device (1) according to the first aspect, the focus identification unit (14) may identify the focus subsystem based on a mathematical model of a subsystem that constitutes the target system and that has a possibility of failure.

This allows the planning device (1) to identify, based on potential losses at failure time and the reliability of subsystems, a subsystem whose profit, reliability, and risk are highly sensitive to modification of the operation plan and maintenance plan.

(3) According to a third aspect, in the planning device (1) according to the first or second aspect, the plan generation unit (16) may generate the operation plan such that the assessment metric is optimized with respect to the focus subsystem; and in a case where the assessment metric of the focus subsystem based on the operation plan does not satisfy an acceptable condition, the plan generation unit modifies the maintenance plan such that the assessment metric is optimized, and then modifies the operation plan such that the assessment metric is optimized with respect to the focus subsystem.

This allows the planning device (1) to try to appropriately optimize an operation plan and a maintenance plan that cannot be optimized at the same time.

(4) According to a fourth aspect, in the planning device (1) according to any one of the first to third aspects, the plan generation unit (16) may search for the operation condition that optimizes the assessment metric within an operation window of the focus subsystem.

This allows the planning device (1) to narrow down the search range for operation conditions and reduce the amount of computation.

(5) According to a fifth aspect, in the planning device (1) according to the fourth aspect, the operation condition may be defined based on a mathematical model of the focus subsystem.

This allows the planning device (1) to search for operation conditions within the range of parameters that may be actually used.

(6) According to a sixth aspect, the planning device (1) according to the fourth or fifth aspect may further include a window output unit (18) configured to output data indicating the operation condition of the focus subsystem.

This allows the user to appropriately operate the target system based on the data outputted by the planning device (1).

(7) According to a seventh aspect, in the planning device (1) according to any one of the fourth to sixth aspects, the window output unit (18) may output graph data indicating a relationship among one or two of control parameters of the focus subsystem, the assessment metric, and the operation condition.

This allows the user to intuitively recognize the operation condition based on visual perception.

(8) According to an eighth aspect, in the planning device (1) according to the sixth or seventh aspect, the mathematical model may be a hydrodynamic model that simulates wear of the focus subsystem caused by a fluid; the plan generation unit may search for an operation condition of a degree of opening of a valve that regulates a flow rate of the fluid based on the mathematical model, generate an operation plan including a damage growth event based on the operation condition, and predict a service life due to wear for the focus subsystem based on the operation plan; and the window output unit may output graph data indicating a relationship between the degree of opening of the valve and wear rate of the focus subsystem.

This allows the planning device (1) to appropriately assess the risk of wear with respect to the focus subsystem through which the fluid flows.

(9) According to a ninth aspect, the planning device (1) according to any one of the first to eighth aspects may further include a state output unit (18) configured to output data indicating a state of the focus subsystem based on the mathematical model of the focus subsystem and a measurement value of a state quantity measured from the focus subsystem.

This allows the user to recognize the current state of the focus subsystem.

(10) According to a tenth aspect, in the planning device (1) according to any one of the first to ninth aspects, the mathematical model of the focus subsystem may include a plurality of simulation models that simulate different physical phenomena.

This allows the planning device (1) to appropriately simulate complex phenomena relating to failure.

(11) According to an eleventh aspect, in the planning device (1) according to the tenth aspect, the mathematical model of the focus subsystem may include a simulation model based on fluid analysis and a simulation model that simulates wear.

This allows the planning device (1) to appropriately simulate complex phenomena relating to failure with respect to the focus subsystem through which the fluid flows.

(12) According to a twelfth aspect, a planning method includes: identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and generating at least one of an operation plan and a maintenance plan such that the assessment metric is optimized with respect to the focus subsystem.

This makes it possible, according to the planning method, to efficiently generate a plan such that the plan is optimized with respect to subsystems whose profit, reliability, and risk are particularly highly sensitive to modification of the operation plan and maintenance plan.

(13) According to a thirteenth aspect, a program causes a computer to execute the following: identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and generating at least one of an operation plan and a maintenance plan such that the assessment metric is optimized with respect to the focus subsystem.

This allows the computer (90) executing the program to efficiently generate a plan such that the plan is optimized with respect to subsystems whose profit, reliability, and risk are particularly highly sensitive to modification of the operation plan and maintenance plan.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A planning device, comprising:
a focus identification unit configured to identify, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and
a plan generation unit configured to generate at least one of an operation plan and a maintenance plan such that the assessment metric is optimized with respect to the focus subsystem.

2. The planning device according to claim 1, wherein the focus identification unit identifies the focus subsystem based on a mathematical model of a subsystem that constitutes the target system and that has a possibility of failure.

3. The planning device according to claim 1, wherein:
the plan generation unit generates the operation plan such that the assessment metric is optimized with respect to the focus subsystem, and
in a case where the assessment metric of the focus subsystem based on the operation plan does not satisfy an acceptable condition, the plan generation unit modifies the maintenance plan such that the assessment metric is optimized, and then modifies the operation plan such that the assessment metric is optimized with respect to the focus subsystem.

4. The planning device according to claim 1, wherein the plan generation unit searches for the operation condition that optimizes the assessment metric within an operation window of the focus subsystem.

5. The planning device according to claim 4, wherein the operation condition is defined based on a mathematical model of the focus subsystem.

6. The planning device according to claim 4, further comprising a window output unit configured to output data indicating the operation condition of the focus subsystem.

7. The planning device according to claim 6, wherein the window output unit outputs graph data indicating a relationship among one or two of control parameters of the focus subsystem, the assessment metric, and the operation condition.

8. The planning device according to claim 6, wherein:
the mathematical model is a hydrodynamic model that simulates wear of the focus subsystem caused by a fluid,
the plan generation unit searches for an operation condition of a degree of opening of a valve that regulates a flow rate of the fluid based on the mathematical model, generates an operation plan including a damage growth event based on the operation condition, and predicts a service life due to wear for the focus subsystem based on the operation plan, and
the window output unit outputs graph data indicating a relationship between the degree of opening of the valve and wear rate of the focus subsystem.

9. The planning device according to claim 1, further comprising a state output unit configured to output data indicating a state of the focus subsystem based on the mathematical model of the focus subsystem and a measurement value of a state quantity measured from the focus subsystem.

10. The planning device according to claim 1, wherein the mathematical model of the focus subsystem includes a plurality of simulation models that simulate different physical phenomena.

11. The planning device according to claim 10, wherein the mathematical model of the focus subsystem includes a simulation model based on fluid analysis and a simulation model that simulates wear.

12. A planning method, comprising:
identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and
generating at least one of an operation plan and a maintenance plan such that the assessment metric is optimized with respect to the focus subsystem.

13. A non-transitory computer readable storage medium storing a program for causing a computer to execute:
identifying, based on a mathematical model that simulates behavior of a plurality of subsystems constituting a target system, from among the plurality of subsystems, a focus subsystem that causes a large change in an assessment metric of the target system in response to a change in at least one of an operation condition and a maintenance condition; and
generating at least one of an operation plan and a maintenance plan such that the assessment metric is optimized with respect to the focus subsystem.
